(19) United States
(12) Patent Application Publication
(10) Pub. No.: US 2014/0052959 A1
(43) Pub. Date: Feb. 20, 2014

(54) Experimental engineering optimization algorithm at point of performance

(71) Applicant: Ronald E. Wagner, Fleming Island, FL (US)

(72) Inventor: Ronald E. Wagner, Fleming Island, FL (US)

(73) Assignee: BAE Systems Information and Electronic Systems Integration, Inc.

(21) Appl. No.: 12/807,918

(22) Filed: Sep. 16, 2010

Related U.S. Application Data
(60) Provisional application No. 61/342,089, filed on Apr. 9, 2010.

(51) Int. Cl. G06F 9/30

(52) U.S. Cl. 712/7; 712/E09.017

(57) ABSTRACT

A method is provided for reducing the data set used in creating an optimization algorithm, thus to permit the use of microprocessors, that in turn permits embedding the optimization algorithm at the point of performance, in which a subset of data points in a performance window is used to derive a vector that is utilized to create an initial optimization algorithm.

### RELATED APPLICATIONS

This Application claims rights under 35 USC §119(e) from U.S. application Ser. No. 61/342,089 filed Apr. 9, 2010, the contents of which are incorporated herein by reference.

### FIELD OF THE INVENTION

This invention relates optimization algorithms and more particularly an optimization algorithm that eliminates unnecessary data by operating on a reduced data set, with the optimization algorithm embedded at a point of performance on a microprocessor.

### BACKGROUND OF THE INVENTION

For many monitoring systems there may be as many as for instance 500 different sensors, each providing data to a central processing station. The data is provided to an optimization algorithm so that the monitored process can be optimized. However, transmitting an unreduced data set transmits unnecessary data to a processing station.

When monitoring or central processing station is utilized to provide optimization of the monitored systems it is often desirable to be able to sort out data that is available on the system that is meaningful to the performance of the system that one is trying to optimize. While there are various optimization systems available, they operate on massive amounts of data and on models whose vectors are not necessarily optimal in the first place. Since most optimization systems require defining vectors in order to monitor performance, it is often unclear from a purely ad hoc approach how one could in essence pick and choose amongst the data in order to be able to provide the optimization functionality.

Taking for instance fleet management, data is collected on so-called CAN data buses or the J-1939 bus. For Class 8 vehicles the data is transmitted on the J-162 OBD2 bus. Each of these buses has a limited bandwidth and only certain parameters can be monitored for optimization purposes.

If one is for instance looking for the amount of nitrous oxide that is emitted from a vehicle and assuming one could associate the amount of nitrous oxide with brake horsepower per foot pound, then one would only have to monitor one variable, i.e. nitrous oxide, to obtain brake horsepower and utilize a suitably tailored optimized algorithm with an appropriate vector for improving performance.

However, the selection of the so-called vector or parameter that is to be most useful in optimization is oftentimes difficult, especially for complicated systems. One way to limit the amount of data transmitted is to provide a specialized vector for an optimization algorithm and run this algorithm on a microprocessor at the point of performance. Microprocessors can be utilized if for instance the vector can be specifically identified so that rather than collecting sensor outputs from numbers of different sensors, only one sensor or small set of sensors need be utilized. With an optimization algorithm functioning at the point of performance, the only data that is transmitted is that reduced data set associated with the particular vector or vectors that have been specifically recognized as maximally affecting performance.

### SUMMARY OF INVENTION

In order to minimize the amount of data necessary, a reduced data set employs an optimization algorithm at the point of performance which operates on vectors that are specifically tailored to those parameters most likely to result in an increase in performance. Thus for markets such as freight, warrior safety, health maintenance and other markets which incorporate massive amounts of data collection, it has not heretofore been deemed desirable to create an optimization algorithm and certainly not to embed it at the point of performance where only microprocessing capabilities are available.

In order to provide for the optimum vectors used by an optimization algorithm at the point of performance, the first step is to predict the shape of the optimization curve or vector and then utilize this vector in an initial optimization algorithm, with the initialized optimization algorithm operating on a reduced data set to permit microprocessor implementation. Thus an optimization algorithm is embeddable in a microprocessor at the point of performance, with the vector monitored being previously established by prediction of the shape of the optimization curve.

In order to predict the shape of the optimization curve a performance window is established for a portion of the data that is available from all of the sensors utilized in the monitoring system. The performance window is a snapshot of the data and a best fit curve through the data in this performance window predicts the shape of the optimization curve. Thus, the subject system uses a best fit algorithm to characterize the data in the performance window.

Thereafter, having derived the shape of the curve, an initial optimization algorithm is tailored for the derived performance vector, with the vector having variables and coefficients. The variables determine the performance vector, and the coefficients determine each variable's contribution to optimization.

The result is that by initially analyzing a massive number of data points for a particular monitored system, one can detect through best fit techniques the vector that describes the operation of the monitored system and therefore permits designing an initial optimization algorithm to improve monitored system performance.

Because of the reduced data set it is possible to embed the initial optimization algorithm at the point of performance in a microprocessor so that no data need be transmitted to a remote site.

In summary, a method is provided for reducing the data set used in creating an optimization algorithm, thus to permit the use of microprocessors, that in turn permits embedding the optimization algorithm at the point of performance, in which a subset of data points in a performance window is used to derive a vector that is utilized to create an initial optimization algorithm.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the predication of an optimization curve for use in an initial optimization algorithm that is in turn embedded in a microprocessor at the point of performance; and,

FIG. 2 is a diagrammatic illustration of a number of data points some of which occur in a performance window, with a vector being the best fit curve through the data points in the performance window.

### DETAILED DESCRIPTION

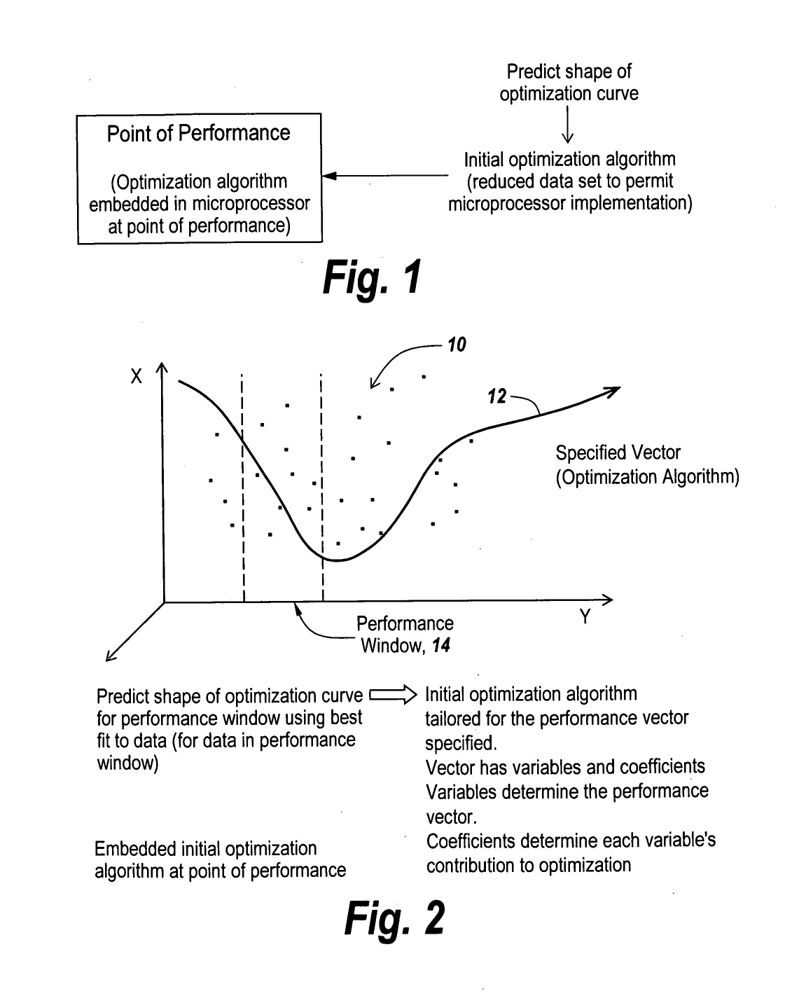

Referring now to FIG. 1, in order to reduce the data set that is required for optimization to a point where it can be handled by a microprocessor at the point of performance, one first predicts the shape of an optimization curve and then uses this curve as a vector for an initial optimization algorithm. Optimization algorithms are common and can be found in the literature. However, one type of optimization algorithm is described in U.S. patent application Ser. No. 12/548,683 by Carolyn Spier filed on Aug. 27, 2009, assigned to the assignee hereof and incorporated herein by reference.

Referring to FIG. 2, if one has on an X, Y and Z plane a set of data points 10 that are derived from the monitored system, the predicted shape of the optimization curve is a best fit to the data as illustrated by vector 12. This vector may be defined for a performance window 14 which takes a limited number of data points within the performance window and provides the best fit to the data through curve fitting techniques. This then becomes the vector used by the initial optimization algorithm to be embedded at the point of performance.

Once the initial optimization algorithm is embedded at the point of performance, the output of this algorithm can be utilized to further characterize the optimal vector through an augmented data set. Thus, the optimization algorithm at the point of performance can itself be corrected or modified to provide better optimization results.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method of reducing the data sets used by an optimization algorithm, comprising the steps of:
generating a data set for a monitored system, the data set having data points;
utilizing curve fitting techniques to provide a best fit curve for the data points, thus to derive a vector;
utilizing the vector to create an initial optimization algorithm; and,
embedding the initial optimization algorithm in a microprocessor at the point of performance of the monitored system.

2. The method of claim 1, wherein the best fit curve is that associated with a subset of the data points in a performance window.

3. The method of claim 2, wherein the performance window is a snapshot of data points derived from the monitored system.

4. The method of claim 1, wherein the vector describes the performance of the monitored system.

5. The method of claim 4, wherein the vector establishes coefficients that determine the contribution of each variable to the optimization provided by the optimization algorithm.

6. The method of claim 5, wherein the coefficients established by the vector are used to create the initial optimization algorithm.

7. The method of claim 1, wherein the results from the initial optimization algorithm are transmitted to a remote processor.

8. The method of claim 7, wherein the amount of data transmitted reflects the utilization of the initial optimization algorithm.

9. The method of claim 8, wherein the transmitted data from the initial optimization algorithm is utilized to correct the coefficients associated with the vector used to create the initial optimization algorithm, the coefficients determining the contribution of each variable to the optimization algorithm.

10. The method of claim 9, wherein the output of the initial optimization algorithm is utilized to generate an expanded data set.

11. The method of claim 10, wherein the expanded data set is utilized to correct the initially derived vector, thus to improve the optimization algorithm.
